(19) United States
(12) Patent Application Publication
(10) Pub. No.: US 2005/0255363 A1
(43) Pub. Date: Nov. 17, 2005

(54) Contact element for a fuel cell stack

(75) Inventor: Andreas Reinert, Neubrandenburg (DE)

Correspondence Address: NIXON PEABODY, LLP, 401 9TH STREET, NW, SUITE 900, WASHINGTON, DC, 20004-2128, US

(73) Assignee: Webasto AG, Stockdorf, DE (US)

(21) Appl. No.: 11/060,303

(22) Filed: Feb. 18, 2005

(30) Foreign Application Priority Data
May 12, 2004 (DE) 10 2004 023 461.2

(51) Int. Cl. H01M 8/02

(52) U.S. Cl. 429/35; 429/34

(57) ABSTRACT

A contact element (7) for a fuel cell stack for connecting the electrodes (3, 4) of two adjacent fuel cells. The contact element is has at least one sealed cavity which is filled with a gas. The gas continuously imparts elasticity to the contact element (7) even at high temperatures, by which reliable contact-making of the electrodes (3, 4) is ensured. Furthermore, a fuel cell stack in which a contact element (7) is used has the anode of one fuel cell electrically connected to the cathode of an opposite fuel cell via the contact element. The contact elements can be tubes or can be formed of corrugated plates that are arranged in mirror image fashion forming channels and are connected at least at an outer area so as to seal the channels relative to the outside.

### BACKGROUND OF THE INVENTION

1. Field of Invention

The invention relates to a contact element for a fuel cell stack for connection of electrodes of two adjacent fuel cells and to a fuel cell stack with at least two planar fuel cells, a bipolar plate or a contact element being provided between each two fuel cells.

2. Description of Related Art

Fuel cells have an ion-conducting electrolyte with which contact is made on either side via two electrodes, i.e., an anode and a cathode. The anode is supplied with a reducing, generally hydrogen-containing, fuel and the cathode is supplied with a oxidizer, for example, air. In combination, the fuel and oxidizer are called working stock below. The electrons which are released in the oxidation of the hydrogen which is contained in the fuel on one electrode are guided via an external load circuit to the other electrode. The chemical energy which is being released is thus directly available in the load circuit with high efficiency as electrical energy.

To achieve higher output, several planar fuel cells are often stacked on one another in the form of a fuel cell stack and are electrically connected in series. For this purpose, there are so-called bipolar plates between each two cells. On the one hand, the bipolar plates connect an anode of one cell to the cathode of the next cell, contact-making as good as possible distributed over the entire electrode surface being necessary. On the other hand, the bipolar plates are used to supply and distribute the working stock over the electrode surfaces. For this purpose, conventionally, channels are formed on each side of the bipolar plate through which the working stock is supplied separately from one another to the respective electrode. In the edge area of the fuel cells, these channels typically pass bunched into an external working stock feed and are sealed relative to the environment.

One general problem in fuel cells is reliable contact-making of the electrodes. The bipolar plates are often made of metal, conversely the electrodes are made either of doped ceramics or graphites. In this case, a material connection, for example, by welding the materials, is not possible. Reliable contact-making can therefore only be achieved via a contact force or a contact pressure.

An additional difficulty is caused by the seal with which the stack is sealed relative to the outside. It lies in one plane with the contact elements and likewise requires sufficient contact force. The force with which the fuel cell stack is pressed together is accordingly divided among the contacts and seal, and shrinkage or creep of the contact or sealing material can adversely change the force ratios. This can lead either to contact problems or to leakiness of the stack.

The elements of a bipolar plate with which the electrodes make contact in the form of a point, a bridge or superficially are called contact elements in summary below. In the configuration of the contact elements, two different basic principles are used.

On the one hand, the contact elements can be made rigid. The contact force is adjusted by pre-tensioning the entire fuel cell stack. The disadvantage in a rigid design of the contacts is that uniform, reliable contact-making is only ensured when very small production tolerances for the thickness of the electrodes and contact elements or bipolar plates are maintained. In addition, there is the problem that the contact forces can adversely change by thermal expansion when the stack heats up during operation.

On the other hand, it is possible to use inherently elastic contact elements. In this concept, both production tolerances and thermal expansion can be equalized by the contact elements; this leads to reliable contact-making. In low temperature fuel cells, for example, a PEMFC (polymer electrolyte membrane fuel cell) which is operated at roughly 100° C., the concept of elastic contact elements is often used due to its advantages since, in this temperature range, the corresponding elastic materials are available. In high temperature fuel cells, especially in a solid oxide fuel cell (SOFC) which is operated at temperatures above 800° C., this is not the case. Materials which can be used at these temperatures either have only very low elastic deformability or lose it over time, such as, for example, metals which recrystallize and thus become soft.

German Patent DE 19645111 C2 discloses an arrangement for a SOFC stack in which there are buffer elements acting as springs on the outside of the stack in the path of the pre-tensioning force. These buffer elements achieve an almost constant contact force over a wide temperature range even with rigid contact elements.

U.S. Pat. No. 6,835,486 discloses a rod-shaped compression element for pre-tensioning a SOFC stack, in which, by a combination of the materials used, a coefficient of thermal expansion which is matched to the stack is achieved. In this way, the contact force can be kept constant either over a wide temperature range or can be changed in a prescribed manner monitored as a function of temperature.

Both approaches call for use of rigid contact elements. An elastic or equalizing element is mounted externally, by which neither production tolerances of the bipolar plates and the electrodes are equalized nor is reliable contact-making for non-elastic seals ensured.

Furthermore, the prior art discloses a bipolar plate which is made of a corrugated metal plate. In this way, guide channels for the working stock are prepared without major machining costs. At the same time, the plate acts as a contact element, resiliency being achieved by the corrugated structure. However, creep and recrystallization processes, in this case, lead to relaxation of the spring action when used in high temperature fuel cells.

### SUMMARY OF THE INVENTION

A primary object of the present invention is, therefore, to devise a contact element which can be continuously elastically deformed even at high temperatures, and to provide a fuel cell in which this contact element is advantageously used.

This object is achieved in accordance with the invention by a contact element which has at least one sealed cavity which is filled with a gas. The object is furthermore achieved by a fuel cell stack in which the anode of one fuel cell is electrically connected to the cathode of an opposite fuel cell via a contact element and/or in which a bipolar plate ia located between each two fuel cells, each bipolar plate having a base plate and tubular contact elements, several tubular contact elements of which run in parallel on at least one side of each bipolar plate, and the anode of one fuel cell being electrically connected to the cathode of an opposite fuel cell opposite via the contact elements.

The basic idea of the invention is based on the fact that gas inclusions permanently impart elasticity to the contact element even at high temperatures. The requirement for the material of the contact elements which surrounds the cavity is simply that it can be deformed. By the gas which is enclosed in the cavity, the contact element is also elastic when the material itself can only be plastically deformed. The elasticity of the contact elements ensures reliable contact and equalization of production tolerances and thermal expansions of the fuel cell stack.

Advantageously, the material for the contact element can be a metal, for example, in the form of a tube in which the gas is enclosed. A tube provided as the contact element can be used as a contact bridge. This approach is, moreover, economical since inexpensive materials can be used.

It is a good idea to use inert gases or rare gases in order to prevent corrosion of the walls of the cavity.

The embodiments of the invention are explained in detail below with reference being made to the accompanying drawings.

### BRIEF DESCRIPTION OF THE DRAWINGS

FIG. 1 shows a bipolar plate with one embodiment of the contact element as of the invention between two fuel cells of a fuel cell stack in a cross-sectional view,

FIG. 2 shows another embodiment of a bipolar plate with the contact element of the invention in cross section, and

FIG. 3 is a cross-sectional view of an embodiment of the contact element in accordance with the invention in which the contact element serves, at the same time, as a bipolar plate.

### DETAILED DESCRIPTION OF THE INVENTION

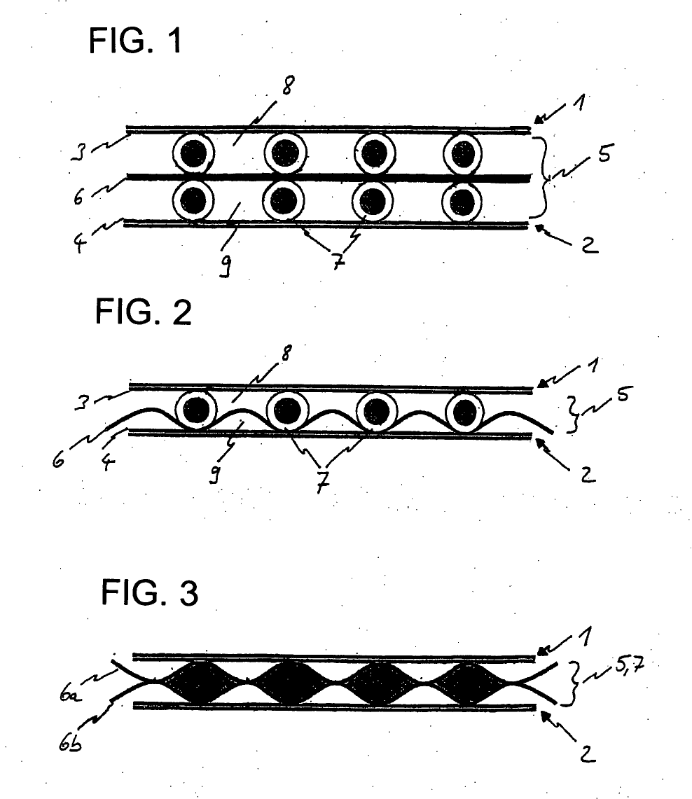

FIG. 1 shows an extract from a fuel cell stack. A MEA (membrane electrode assembly) of a first fuel cell 1 and a MEA of a second fuel cell 2 are shown. The MEA of the first fuel cell 1 has a cathode 3 and the MEA of the second fuel cell 2 has an anode 4, the cathode 3 and anode 4 facing one another. Between the cathode 3 and the anode 4 there is a bipolar plate 5 which is formed of a base plate 6 and contact elements 7. In this way, channels for the oxidizer 8 are formed between the cathode 3 and the base plate 6, and analogously, channels for the fuel 9 are formed between the base plate 6 and the anode 4.

In this embodiment, the contact elements 7 are made as tubes. The contact elements 7 are located parallel to one another on both sides of the base plate 6 and are either securely connected to the base plate 6 or are at least fixed in their position. This unit of the base plate 6 and the contact elements 7 forms the bipolar plate 5 which, on the one hand, electrically connects the cathode 3 and the anode 4 to one another, and on the other hand, separates the gas spaces over the cathode 3 from the gas spaces over the cathode 4. At the same time, channels for the oxidizer 8 and channels for the fuel 9 for distribution of the working stock are formed by the arrangement of the tubular contact elements 7. Requirements for the material for the base plate 6 and for the contact elements 7 are electrical conductivity and for the contact elements 7, in addition, deformability. These requirements result in that a metal and especially a ferritic steel which is chemically inert even at high temperatures is a suitable and moreover economic material.

The contact elements 7 are sealed gas-tight on both ends; this can occur in the case of metal tubes by squeezing and/or welding or using an inserted and sealed plug. In the simplest case, the gas charge is air at atmospheric temperature. However, to protect the inner surfaces, advantageously, a rare or inert gas or a corresponding mixture known as a protective gas can also be used. Furthermor, it is possible to adapt the desired internal pressure at the operating temperature by the gas charge being brought to a defined overpressure or underpressure when filling before sealing of the tubes.

In the illustrated arrangement, the channels for the oxidizer 8 and the channels for the fuel 9 run parallel to one another (concurrent flow or counterflow technology). It is likewise possible to allow the contact elements, and thus, the gas flows to run at 90° relative to one another on the, respective, anode and cathode side (cross-flow technology).

FIG. 2 likewise shows an extract from a fuel cell stack. In contrast to the embodiment in FIG. 1, the bipolar plate 5 in this example is formed from a corrugated base plate 6 and contact elements 7 are located on only one side of the base plate 6. The contact elements 7 are also made here as tubes which are sealed gas-tight, so that what is noted with regard to the FIG. 1 embodiment concerning the material selection and possible production method applies here too. The illustrated arrangement enables a very compact construction of the bipolar plate 5. In turn, the gas spaces over the cathode 3 and anode 4 are separated from another and at the same time the cathode 3 and anode 4 are electrically connected to one another by the base plate 6. Fuel cells, mainly high temperature fuel cells, such as SOFC, are often operated with an excess of oxidizer. This fact can be taken into account in the illustrated embodiment to the extent that the cross sections of the channels for the oxidizer 8 are larger than the corresponding channels for the fuel 9 due to suitable shaping of the base plate 6.

FIG. 3 shows an alternative configuration of the contact element 7. In turn, the figure shows an extract from a fuel cell stack with the MEA of a first fuel cell 1 and the MEA of a second fuel cell 2. The contact element 7 and the bipolar plate 5, in this case, are integrated in one unit. To do this, two corrugated base plates 6a, 6b are placed on top of one another in a mirror image to one another and are connected to one another on their periphery in a gas-tight manner. In this way, a structure is formed with parallel lengthwise ribs which are almond-shaped in their cross section. To stabilize this structure relative to the internal gas pressure, the base plates 6a, 6b can, in addition, be connected to one another at the contact points between the individual ribs, for example, by spot welds or weld seams. The connection can be made either such that, as before, gas exchange between the individual ribs is possible. This ensures that in all ribs the same gas pressure prevails and they thus have the same spring action. Alternatively, the connection can be made such that the individual ribs are separated gas-tight from one another. This embodiment has the advantage that, when a rib leaks, the entire bipolar plate 5 does not lose its spring action and collapse. When a metal is used for the base plates 6a, 6b, especially laser welding is suited for their connection and sealing.

The criteria named in conjunction with FIG. 1 apply to this integrated embodiment of the bipolar plate 5 and the contact elements 7 with respect to the material selection and gas charge.

1. Contact element for a fuel cell stack for connection of electrodes of two adjacent fuel cells, the contact element having at least one sealed cavity which is filled with a gas.

2. Contact element as claimed in claim 1, wherein the contact element is formed from a deformable material and has elastic properties due to the gas in the sealed cavity.

3. Contact element as claimed in claim 1, wherein the contact element is made of metal.

4. Contact element as claimed in claim 1, wherein the gas is a rare gas or an inert gas.

5. Contact element as claimed in claim 1, wherein at least one cavity is formed by a tube.

6. Contact element as claimed in claim 1, wherein several cavities are formed by two corrugated base plates which are arranged in a mirror image manner relative to one another, the base plates being connected to one another in an outer area such that the resulting cavities are sealed gas-tight relative to the environment.

7. Contact element as claimed in claim 6, wherein the base plates are made of a ferritic steel.

8. Contact element as claimed in claim 6, wherein the base plates have connecting seams on their surfaces which run in parallel.

9. Contact element as claimed in claim 8, wherein the cavities are separated from one another by the connecting seams which are sealed gas-tight relative to one another.

10. Contact element as claimed in claim 8, wherein the seams between the base plates comprise laser welds.

11. Fuel cell stack, comprising:
at least two planar fuel cells, each of which has an anode and a cathode, and
a bipolar plate located between each two fuel cells,
wherein each bipolar plate has a base plate and tubular contact elements, several tubular contact elements of which run in parallel on at least one side of each bipolar plate, and wherein the anode of one fuel cell is electrically connected to the cathode of an opposite fuel cell opposite via the contact elements.

12. Fuel cell stack as claimed in claim 11, wherein the base plate is corrugated.

13. Fuel cell stack as claimed in claims 11, wherein the base plate is made of a ferritic steel.

14. Fuel cell stack as claimed in claims 11, wherein the tubular contact elements are filled with a gas.

15. Fuel cell stack as claimed in claim 14, wherein the contact element is formed from a deformable material and has elastic properties due to the gas in the sealed cavity.

16. Fuel cell stack as claimed in claim 15, wherein the deformable material is a metal.

17. Fuel cell stack as claimed in claim 14, wherein the gas is a rare gas or an inert gas.

18. Fuel cell stack, comprising:
at least two planar fuel cells each of which has an anode and a cathode, and
a contact element located between each two fuel cells,
wherein the anode of one fuel cell is electrically connected to the cathode of an opposite fuel cell via the contact element.

19. Fuel cell stack as claimed in claim 18, wherein several cavities are formed by two corrugated base plates which are arranged in a mirror image manner relative to one another, the base plates being connected to one another in an outer area such that the resulting cavities are sealed gas-tight relative to the environment.

20. Contact element as claimed in claim 19, wherein the base plates are made of a ferritic steel.

21. Contact element as claimed in claim 19, wherein the base plates have connecting seams on their surfaces which run in parallel.

22. Contact element as claimed in claim 21, wherein the cavities are separated from one another by the connecting seams which are sealed gas-tight relative to one another.

23. Contact element as claimed in claim 21, wherein the connections between the base plates comprise laser welds.
